(19) United States
(12) Patent Application Publication
(10) Pub. No.: US 2003/0112868 A1
(43) Pub. Date: Jun. 19, 2003

(54) Shape assisted padding for object-based coding

(75) Inventors: Yong Yan, Yorktown Heights, NY (US); Kiran Challapali, New City, NY (US); Yun-Ting Lin, Ossining, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/023,069

(22) Filed: Dec. 17, 2001

(51) Int. Cl. H04N 7/12

(52) U.S. Cl. 375/240.12; 375/240.26; 375/240.15

(57) ABSTRACT

A system and method for encoding a video image using object-based encoding. The system comprises a foreground encoding system for coding a foreground shape in a foreground object plane; and a background encoding system for coding a background object plane, wherein the background encoding system pads a masked area in the background object plane, and wherein the masked area is determined from data associated with the foreground shape.

### BACKGROUND OF THE INVENTION

1. Technical Field

The present invention relates to object-based coding systems, and more particularly relates to a system and method for padding overlaid areas in a background object plane.

2. Related Art

With the advent of personal computing and the Internet, a huge demand has been created for the processing of digital data, and in particular, digital video data. However, the ability to efficiently process and encode video data remains an ongoing challenge.

To address this issue, systems are being developed in which coded representations of video signals are broken up into video elements or objects that can be independently encoded and manipulated. For example, MPEG-4 is a compression standard developed by the Moving Picture Experts Group (MPEG) that operates on video objects. Each video object (VO) is characterized by temporal and spatial information in the form of shape, motion and texture information, which are coded separately.

Instances of video objects in time are called video object planes (VOP). Using this type of representation allows enhanced object manipulation, bit stream editing, object-based scalability, etc. Each VOP can be fully described by texture and shape representations. The shape information can be represented as a binary shape mask, the alpha plane, or a gray-scale shape for transparent objects.

In object-based representation of video content there are generally two scenarios where video objects can appear. In the first scenario, a frame is formed by two or more VOPs that are spatially disjoined, i.e., each VOP does not cover an entire frame. In this case, the union of the VOPs covers the entire frame. Thus, for example, the foreground plane and background plane “compliment” each other. In the second scenario, each VOP comprises a complete layer of its own in each frame. In this case, there are no holes in any of the VOPs, and each of the VOPs overlay one another at a defined Z-value or depth value.

In current applications that employ these scenarios, hidden or overlaid areas that reside in the background plane are coded, even though they are not ultimately visible in the final image. Accordingly, an opportunity exists to reduce processing overhead by eliminating unnecessary coding of hidden areas.

### SUMMARY OF THE INVENTION

The present invention addresses the above-mentioned issues, as well as others, by providing an object-based encoding system and method that pads hidden areas in VOPs in order to reduce processing. In a first aspect, the invention provides an object-based encoding system for encoding a video image, comprising: a foreground encoding system for coding a foreground shape in a foreground object plane; a padding system that pads a masked area in a background object plane, wherein the masked area is determined from data associated with the foreground shape; and a background encoding system for coding the background object plane.

In a second aspect, the invention provides a method of encoding a video image in an object-based encoding system, comprising: coding a foreground shape in a foreground object plane; padding a masked area in a background object plane, wherein the masked area is determined from data associated with the foreground shape; and coding the background object plane.

In a third aspect, the invention provides a program product stored on a recordable medium for encoding a video image in an object-based encoding system, comprising: means for coding a foreground shape in a foreground object plane; means for padding a masked area in a background object plane, wherein the masked area is determined from data associated with the foreground shape; and means for coding the background object plane.

### BRIEF DESCRIPTION OF THE DRAWINGS

An exemplary embodiment of the present invention will hereinafter be described in conjunction with the appended drawings, where like designations denote like elements, and:

FIG. 1 depicts a block diagram of an object-based encoder in accordance with the invention.

FIG. 2 depicts an exemplary foreground and background object plane that are spatially disjointed.

FIG. 3 depicts and exemplary foreground and background object plane that are overlaid.

### DETAILED DESCRIPTION OF THE INVENTION

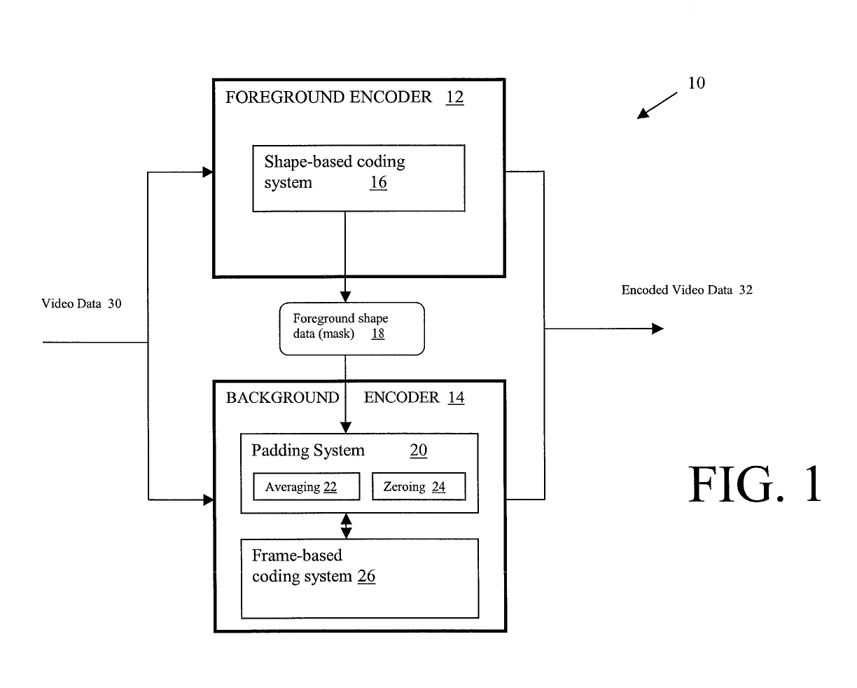

Referring now to the drawings, FIG. 1 depicts an object-based encoding system 10 for encoding video data 30. Object-based encoding system 10 comprises a foreground encoder 12 for encoding a foreground object plane, and a background encoder 14 for encoding a background object plane. While this exemplary embodiment describes a system for processing two VOPs (foreground and background), it should be understood that invention extends to any system that processes more than two VOPs. Moreover, the terms “foreground” and “background” are used herein to describe the relative position of the two VOPs being processed, and do not limit the actual number or location of the VOPs along the Z-axis.

Referring again to FIG. 1, foreground encoder 12 comprises a shaped-based coding system 16 for coding a shape or object as it appears in the foreground object plane. Shape-based coding systems, such as those that operate pursuant to the MPEG-4 standard, are known in the art and therefore are not described in detail herein. In addition to coding the object in the foreground object plane, shape-based coding system 16 generates foreground shape data 18. Foreground shape data 18 may comprise, for example, coordinates of the object being encoded. The region defined by the foreground shape data 18 defines a mask that is utilized by the background encoder 14, as explained below.

Background encoder 14 comprises a padding system 20 and frame-based coding system 26. In order to reduce processing complexity, frame-based coding system 26 codes the background as an entire frame, as opposed to coding individual objects. Frame-based coding systems, such as those that operate pursuant to the MPEG-2 and MPEG-4 standard, are likewise known in the art and are not described in detail herein. Padding system 20 reads in the foreground shape data 18 and calculates a masked area in the background frame. The masked area will essentially comprise a “shadow” of the foreground object. Padding system 20 then causes frame-based coding system 26 to pad the frame with arbitrary values in the masked area. By padding arbitrary values into the masked area, coding overhead will be reduced, but picture quality will not suffer since only hidden areas are affected.

As shown, padding system 20 depicts two exemplary padding techniques, averaging 22, and zeroing 24. In an exemplary embodiment, the masked area is padded with zeros when frame being processed comprises a P or B frame. In this case, coding overhead is reduced because the processing of zeros is computationally less complex than the processing of actual data. When the frame being processed comprises an I frame, an average value from the image pixels in the masked region of the background could be utilized to pad the masked region. Similarly, processing of uniform values is computationally less complex than processing diverse values. In another exemplary embodiment involving texture coding, the masked area could be padded with darker values, which have reduced bits and require less computations to code. It should be understood that any value(s) or techniques that reduce processing and maintain picture quality could be utilized as padding, and the techniques described herein are for exemplary purposes only.

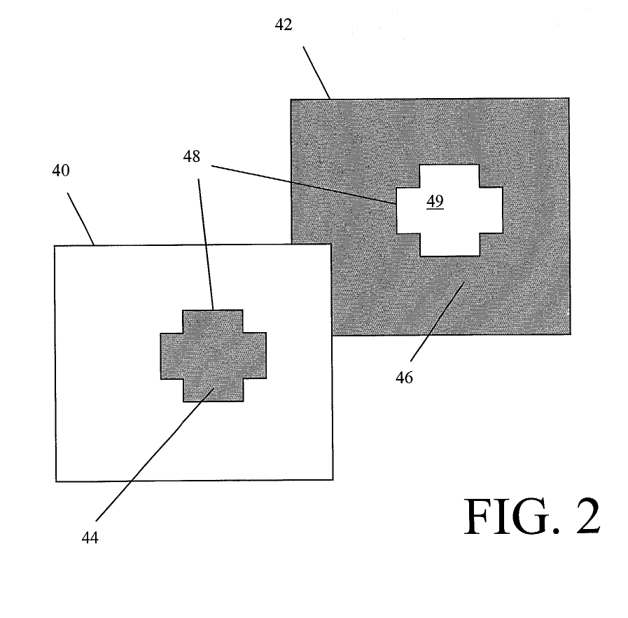

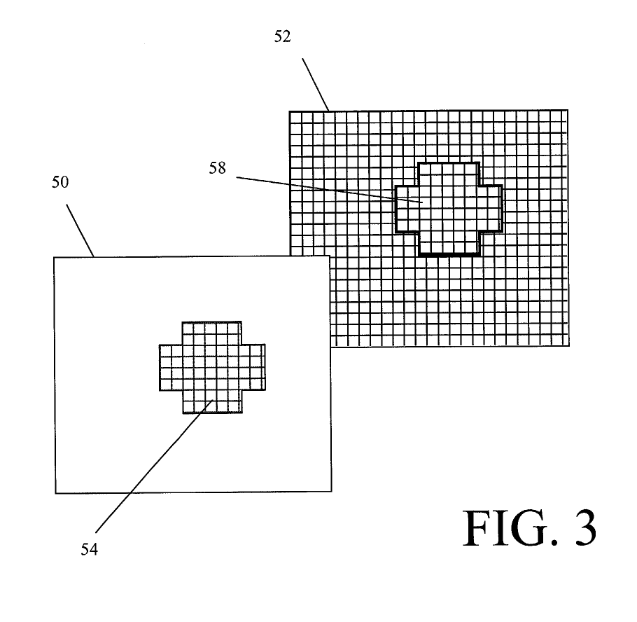

FIGS. 2 and 3 depict two exemplary scenarios for implementing the present invention. FIG. 2 depicts a first scenario wherein a foreground plane 40 and a background plane 42 are spatially disjointed. As can be seen, foreground plane 40 contains an object 44 that compliments an object 46 in the background plane, such that there is no overlap. However, both planes 40, 42 share a common contour or shape 48, which must be coded for both planes. According to the present invention however, when the background plane is coded, the masked area 49 will be padded with some arbitrary values to reduce the shape coding overhead. Thus, if the image comprised a P frame, area 49 could be padded with zeros.

FIG. 3 depicts a second scenario having a foreground plane 50 and a background plane 52 that overlay each other. In this case, foreground plane 50 comprises an object 54 that overlays a region (or masked area) 58 of the background plane 52. In a situation where, e.g., a system was required to detect and segment object 54 from a scene (i.e., automatic segmentation), then the texture would remain the same for both the object 54 and the background plane 52. Thus, texture coding of regions 54 and 58 would be essentially identical. Accordingly, the present invention causes region 58 to be padded with some arbitrary values in order to reduce computational overhead.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing descriptions of the embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. An object-based encoding system for encoding a video image, comprising:
a foreground encoding system for coding a foreground shape in a foreground object plane;
a padding system that pads a masked area in a background object plane, wherein the masked area is determined from data associated with the foreground shape; and
a background encoding system for coding the background object plane.

2. The object-based encoding system of claim 1, wherein the foreground encoding system utilizes a shape-based encoding scheme.

3. The object-based encoding system of claim 1, wherein the background encoding system utilizes a frame-based encoding scheme.

4. The object-based encoding system of claim 1, wherein the masked area is padded with zeros when the video image comprises a P or B frame.

5. The object-based encoding system of claim 1, wherein the masked area is padded with an average pixel value of the masked area when the video image comprises an I frame.

6. The object-based encoding system of claim 1, wherein the object based coding system comprises an MPEG-4 encoder.

7. A method of encoding a video image in an object-based encoding system, comprising:
coding a foreground shape in a foreground object plane;
padding a masked area in a background object plane, wherein the masked area is determined from data associated with the foreground shape; and
coding the background object plane.

8. The method of claim 7, wherein the foreground shape is encoded with a shape-based encoding scheme.

9. The method of claim 7, wherein the background shape is encoded utilizing a frame-based encoding scheme.

10. The method of claim 7, wherein the masked area is padded with zeros when the video image comprises a P or B frame.

11. The method of claim 7, wherein the masked area is padded with an average pixel value of the masked area when the video image comprises an I frame.

12. The method of claim 7, wherein the object based coding system comprises an MPEG-4 encoder.

13. A program product stored on a recordable medium for encoding a video image in an object-based encoding system, comprising:
means for coding a foreground shape in a foreground object plane;
means for padding a masked area in a background object plane, wherein the masked area is determined from data associated with the foreground shape; and
means for coding the background object plane.

14. The program product of claim 13, wherein the foreground shape is encoded with a shape-based encoding scheme.

15. The program product of claim 13, wherein the background shape is encoded utilizing a frame-based encoding scheme.

16. The program product of claim 13, wherein the masked area is padded with zeros when the video image comprises a P or B frame.

17. The program product of claim 13, wherein the masked area is padded with an average pixel value of the masked area when the video image comprises an I frame.

18. The program product of claim 13, wherein the object based coding system comprises an MPEG-4 encoder.

19. The program product of claim 13, wherein the background plane is texture coded.

20. The program product of claim 13, wherein the background plane is shape coded.
